(19) United States
(12) Patent Application Publication
(10) Pub. No.: US 2025/0259381 A1
(43) Pub. Date: Aug. 14, 2025

(54) IMAGE PROCESSING DEVICE FOR LOW-LOAD GENERATING OF HIGH-RESOLUTION IMAGE WITHOUT DELAY, HEAD-MOUNTED DISPLAY DEVICE, IMAGE PROCESSING METHOD, AND NON-TRANSITORY COMPUTER READABLE MEDIUM

(71) Applicant: CANON KABUSHIKI KAISHA, Tokyo (JP)

(72) Inventors: KYOSUKE SATO, Kanagawa (JP); NAOKI NOMURA, Kanagawa (JP)

(21) Appl. No.: 19/041,286

(22) Filed: Jan. 30, 2025

(30) Foreign Application Priority Data
Feb. 8, 2024 (JP) 2024-017945

(51) Int. Cl. G06T 17/00; G02B 27/01; G06F 3/01

(52) U.S. Cl. CPC G06T 17/00; G02B 27/017; G06F 3/012; G06F 3/013

(57) ABSTRACT

An image processing device includes one or more processors and/or circuitry configured to: perform first setting processing to set a first region that is a region rendered in higher resolution than other regions in a VR image; perform second setting processing to set a second region to which preparatory processing is applied in order to perform rendering in the resolution of the first region, based on user information relating to a first user visually recognizing the VR image, and region information relating to a region that is set in accordance with conditions not related to the first user; and perform generating processing to generate the VR image based on the first region and the second region.

### BACKGROUND OF THE INVENTION

### Field of the Invention

The present invention relates to an image processing device for low-load generating of high-resolution image without delay, a head-mounted display device, an image processing method, and a non-transitory computer readable medium.

### Description of the Related Art

A head-mounted display (HMD) is a display device that can display 360-degree panorama images on a display. An HMD can be worn on the head of a user or be worn like goggles by the user, enabling the user to view images of virtual space from any viewpoint.

Services are coming into widespread use that display images of virtual space on HMDs connected to a network, and provide games and various types of events (live performances, seminars, and so forth), whereby users experience virtual reality (VR). VR images that represent virtual space include virtual pictures generated in accordance with actual pictures shot by a camera for VR, and a VR format.

Japanese Patent Application Publication No. 2019-121394 discloses technology for reducing wait time from moving a viewpoint until display, by acquiring, in advance, part of data used for rendering a display image as a reference image, as viewed from a viewpoint set on the basis of the height of the eyes of the user, or the like.

Even if the reference image viewed from the viewpoint of the user him/herself is acquired in advance, and a high-resolution image can be generated without delay using the reference image, there is a possibility that delay will occur in image generation in a case in which the user moves his/her line of sight to a region that he/she has not visually recognized, and there is no reference image therefore. Also, in a case in which high-resolution images are generated that also include regions that the user has not visually recognized, the processing load of the HMD will increase.

### SUMMARY OF THE INVENTION

The present invention provides an image processing device that can perform low-load generation of high-resolution images without delay, in a case in which a user viewing a VR image moves his/her line of sight.

An image processing device of the present invention includes one or more

processors and/or circuitry configured to: perform first setting processing to set a first region that is a region rendered in higher resolution than other regions in a VR image; perform second setting processing to set a second region to which preparatory processing is applied in order to perform rendering in the resolution of the first region, based on user information relating to a first user visually recognizing the VR image, and region information relating to a region that is set in accordance with conditions not related to the first user; and perform generating processing to generate the VR image based on the first region and the second region.

Further features of the present invention will become apparent from the following description of exemplary embodiments with reference to the attached drawings.

### BRIEF DESCRIPTION OF THE DRAWINGS

FIG. 1A is a diagram illustrating a configuration of a VR system;

FIG. 1B is a diagram illustrating a functional configuration of an HMD;

FIGS. 2A and 2B are diagrams for describing foveated rendering;

FIGS. 3A and 3B are diagrams for describing movement of a line of sight of a user to an area that is visually recognized;

FIG. 4 is a diagram for describing movement of the line of sight of the user to an area that is not visually recognized;

FIG. 5A is a diagram illustrating a configuration of a VR system according to a first embodiment;

FIG. 5B is a diagram illustrating a functional configuration of an HMD;

FIG. 6 is a flowchart exemplifying setting processing of a second region;

FIG. 7 is a flowchart exemplifying acceptance determination processing regarding a share request;

FIG. 8 is a diagram for describing effects of the first embodiment;

FIG. 9 is a diagram for describing setting of the second region in a third embodiment; and

FIG. 10 is a diagram for describing setting of the second region in a fourth embodiment.

### DESCRIPTION OF THE EMBODIMENTS

### First Embodiment

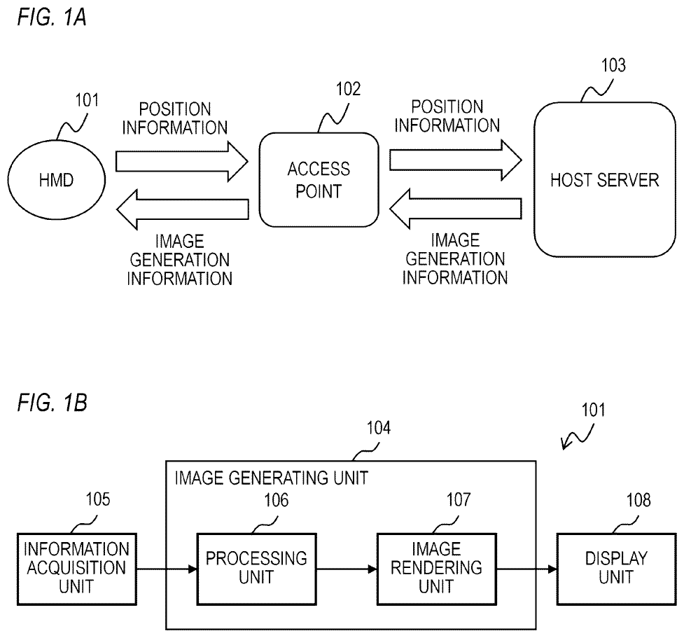

Embodiments of the present invention will be described below with reference to the drawings. A configuration of a virtual reality (VR) system that provides a VR service, and a functional configuration of a head-mounted display (HMD), will be described with reference to FIGS. 1A and 1B. FIG. 1A is a diagram exemplifying the configuration of the VR system. The VR system illustrated in FIG. 1A includes an HMD 101, an access point 102, and a host server 103.

The HMD 101 worn by a user has a plurality of detection units, and can detect the line of sight of the user, and so forth. The access point 102 is a wireless network access point, such as a Wi-Fi router or the like, and is used for network connection of the HMD 101 to an external terminal. The host server 103 is network-connected to the HMD 101 via the access point 102.

The host server 103 transmits image generation information used for generating a VR image to the HMD 101. In a case of providing a VR service in which a plurality of users participate, the host server 103 centrally manages information of the users (user information) that is received from the HMDs 101 worn by each of the users. The host server 103 assigns position information in virtual space to each of the users, and transmits image generation information for generating VR images, in which the plurality of users are present in the same space, to the HMDs 101 of the respective users. The HMDs 101, upon receiving the image generation information from the host server 103, generate VR images for the user to view, using the image generation information that is received.

Processing of generating a VR image, and displaying the generated image to a user, will be described with reference to FIG. 1B. FIG. 1B is a block diagram exemplifying a functional configuration of the HMD 101. The HMD 101 has an image generating unit 104, an information acquisition unit 105, and a display unit 108. The image generating unit 104 includes a processing unit 106 and an image rendering unit 107.

The information acquisition unit 105 acquires the image generation information transmitted from the host server 103, and the user information of the user wearing the HMD 101. The processing unit 106 of the image generating unit 104 performs processing of generating images in accordance with a state of the user, on the basis of the image generation information and user information acquired by the information acquisition unit 105. For example, the processing unit 106 identifies a region the user is viewing, on the basis of a distribution of line-of-sight positions of the user. The image rendering unit 107 renders and generates images on the basis of the processing by the processing unit 106. For example, the image rendering unit 107 renders a region that is distinguished as being the region that the user is viewing with high precision. The display unit 108 displays the images generated by the image generating unit 104 to the user.

In the VR system illustrated in FIG. 1A, the HMD 101 that the user wears receives the image generation information held by the host server 103, and generates an image to be displayed to the user by using the image generating unit 104. In order to provide the user with a natural VR image, the HMD 101 is preferably capable of displaying high-resolution pictures without delay, regardless of the direction in which the user is looking.

With regard to this demand, there is known image generation technology called “foveated rendering”. Foveated rendering is image generating technology in which a center portion of a display image is generated in high resolution, and the resolution of the periphery thereof is lowered. The HMD 101 uses foveated rendering, which enables the portion that the user is looking at to be displayed in high resolution and the resolution of other portions to be lowered, thereby providing the user with a high-resolution image. Also, the HMD 101 lowers the resolution of portions that the user is not looking at, which enables calculation costs for unnecessary image generation to be suppressed, and hardware-based calculation resources to be effectively used.

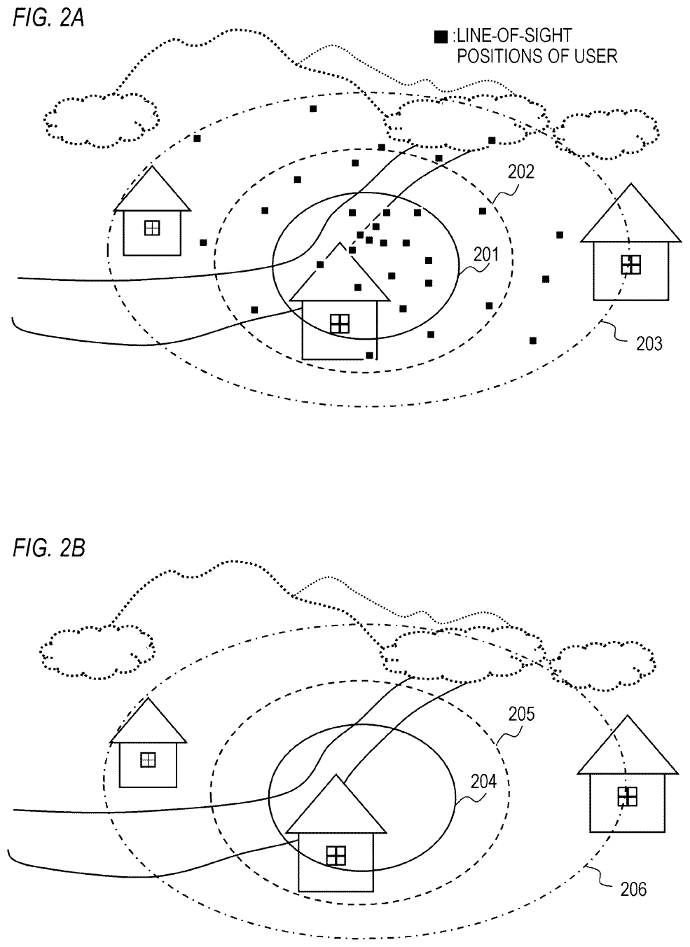

FIGS. 2A and 2B are diagrams for describing foveated rendering. FIG. 2A is a schematic diagram of a VR image that the user wearing the HMD 101 is visually recognizing. VR images include omnidirectional images (full-spherical images) image-captured with an omnidirectional camera (full-spherical camera), panorama images that have a broader picture range (effective picture range) than the display range that can be displayed at once on the display unit 108, and so forth. The black square marks in FIG. 2A are detection results of line-of-sight positions of the user.

An area 201 surrounded by a solid line in FIG. 2A is an area in which line-of-sight positions of the user are detected in a concentrated manner. An area 202 surrounded by a dashed line (excluding the area 201) is an area in which fewer line-of-sight positions of the user are detected than in the area 201. An area 203 surrounded by a dash-dotted line (excluding areas 201 and 202) is an area that is in the field of view of the user, but is hardly recognized by the user.

In foveated rendering, a central field of view and a peripheral field of view are distinguished by analyzing distribution information of line-of-sight positions. In the distribution of line-of-sight positions illustrated in FIG. 2A, the area 201 is the area that line-of-sight positions of the user are detected in a concentrated manner, and is distinguished as being the central field of view of the user. The area 202 does not have as many line-of-sight positions detected as in the area 201, but line-of-sight positions are detected at closer intervals as compared to the area 203, and accordingly is distinguished as being a first peripheral field of view. Line-of-sight positions are detected more sparsely in the area 203 as compared to the area 202 of the user, and accordingly is distinguished as being a second peripheral field of view.

The processing unit 106 of the HMD 101 can distinguish the central field of view, the first peripheral field of view, and the second peripheral field of view, from distribution information of line-of-sight positions of the user. The processing unit 106 transmits information of the fields of view that are distinguished to the image rendering unit 107.

FIG. 2B is a diagram for describing a state in which the panorama image in FIG. 2A is subjected to foveated rendering. A central field of view 204 is an area distinguished on the basis of the area 201 in FIG. 2A. A first peripheral field of view 205 is an area distinguished on the basis of the area 202 in FIG. 2A. A second peripheral field of view 206 is an area distinguished on the basis of the area 203 in FIG. 2A

The image rendering unit 107 generates an image on the basis of results of distinguishing performed by the processing unit 106. Specifically, the image rendering unit 107 generates a high-resolution image for the central field of view 204, generates an image in which the resolution is lowered as compared to the central field of view 204 for the first peripheral field of view 205, and generates an image in which the resolution is lowered as compared to the first peripheral field of view 205 for the second peripheral field of view 206.

By generating images such that the range of the central field of view has high resolution, through distinguishing the central field of view of the user using information of line-of-sight positions of the user, the HMD 101 can provide VR images that are more immersive.

Also, regions that the user can visually recognize are analyzed in advance by the processing unit 106, and accordingly the image rendering unit 107 can apply preparatory processing to the first peripheral field of view and the second peripheral field of view for rendering images in high resolution. Hence, even in a case in which the user moves his/her viewpoint from the central field of view to the first peripheral field of view or the second peripheral field of view, the image generating unit 104 can generate images without delay. In the following description, the central field of view in which images are rendered in high resolution will be referred to as “first region”. Also, the first peripheral field of view and the second peripheral field of view to which preparatory processing is applied in order to render images in high resolution will be referred to as “second region”

Preparatory processing for rendering images in high resolution is, for example, executing computation processing in advance to estimate change in color tinges, change in the way that light strikes, and so forth, in accordance with change in angle, in order to render in high resolution. Also, preparatory processing for rendering images in high resolution may include mapping degrees of importance of line-of-sight positions within the image from results of detecting line-of-sight positions of the user, assigning pixel values in accordance with the degrees of importance, and so of forth.

FIG. 2B illustrates an example in which the first region for rendering images in high resolution, and the second region to which preparatory processing is applied in order to render images in high resolution, are separated on the basis of line-of-sight positions of the user. However, the VR system also provides services assuming exchange among a plurality of users. Examples of services provided to a plurality of users include a case of a plurality of users gaming together, a case of a plurality of users taking a trip together through virtual space (virtual tour), and so forth.

In a service form directed to a plurality of users, users may share viewpoints or the host server 103 may generate events (a volcano erupting, a whale flying, or the like), at unexpected timings. In a case in which viewpoints are shared or an event occurs unexpectedly, there is a possibility that the line of sight of the user will move to an area that the user has not visually recognized. That is to say, preparation is preferably made in advance, such that the HMD 101 can perform high-resolution rendering in areas other than those in which line-of-sight positions are detected.

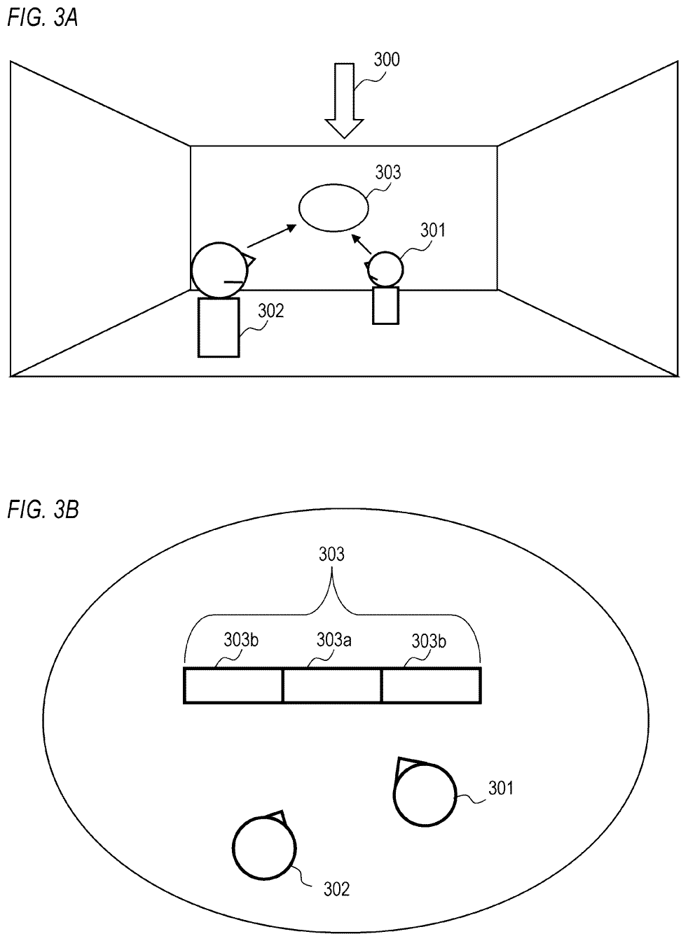

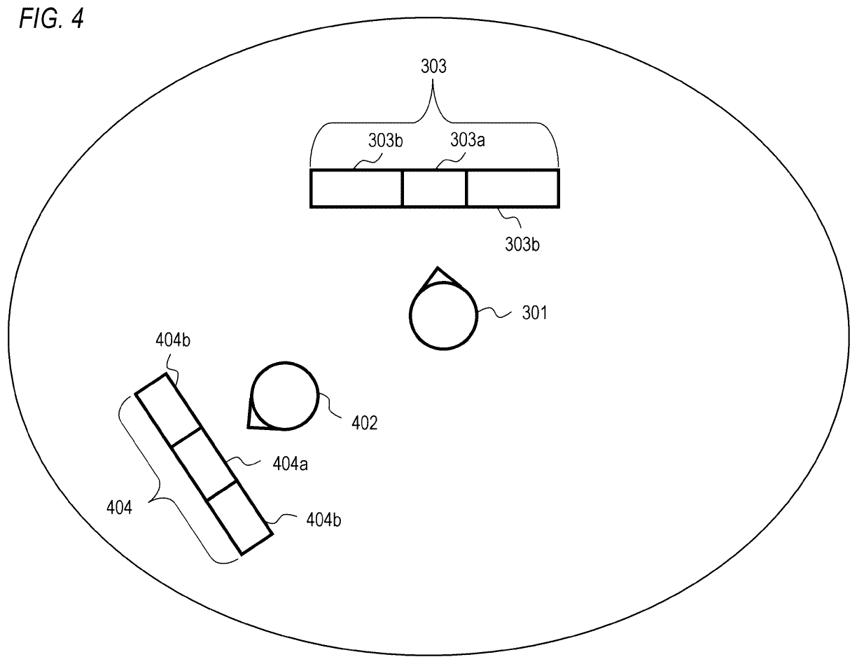

However, in a case of generating images on the basis of information of line-of-sight positions of the user, handling situations in which the user moves his/her line of sight to an area that he/she has not visually recognized is difficult. Movement of the line of sight of the user will be described with reference to FIGS. 3A, 3B and FIG. 4. FIGS. 3A and 3B are diagrams for describing movement of a line of sight to an area that is visually recognized by the user. FIG. 4 is a diagram for describing movement of the line of sight to an area that is not visually recognized by the user.

FIG. 3A illustrates a situation in which a plurality of users are playing a VR game in the same virtual space. A user 301 and a user 302 are each users wearing the HMD 101 in the VR system described by way of FIG. 1A, and can coexist within the same virtual space in a simulated manner, on the basis of information from the host server 103. A visual recognition area 303 that is encircled by a solid line is an area that is visually recognized by the user 301 and the user 302.

FIG. 3B is a plan view of the virtual space illustrated in FIG. 3A as viewed from a direction of an arrow 300. The visual recognition area 303 includes a first region 303a in which line-of-sight positions of the user 301 and the user 302 are concentrated, and second regions 303b in which line-of-sight positions thereof are not concentrated, which are distinguished by foveated rendering. In the example in FIG. 3A, the user 301 and the user 302 are playing with a common objective set within the VR game, and accordingly the area 303 matches. In a VR service in which a plurality of users are expected to be viewing the same visual recognition area, normally, the users do not move their lines of sight to an out-of-visual-recognition area (an area which has not been visually recognized by the users) at an unexpected timing.

In contrast, FIG. 4 describes a case in which the line of sight of the user moves from the visual recognition area 303 to an out-of-visual-recognition area. FIG. 4 is a plan view, looking down on the virtual space in the same way as in FIG. 3B. In FIG. 4, the user 301 is visually recognizing the visual recognition area 303 in the same way as in FIG. 3B. The visual recognition area 303 includes the first region 303a and the second region 303b. Also, a user 402 is visually recognizing a visual recognition area 404. The visual recognition area 404 includes a first region 404a in which line-of-sight positions of the user 402 are concentrated, and second regions 404b in which line-of-sight positions are not concentrated.

Assumption will be made that the VR service being used by the users in FIG. 4 is a virtual tour in which users can freely enjoy trips in the virtual space, for example. FIG. 4 depicts a virtual tour in which the objective of the event is not limited, unlike the services of the VR game exemplified in FIGS. 3A and 3B, and accordingly, the users are each visually recognizing different areas. That is to say, the visual recognition area 404 that the user 402 is visually recognizing is an out-of-visual-recognition area for the user 301, and is not detected from the HMD 101 that the user 301 is wearing.

In the state illustrated in FIG. 4, in a case in which the user 402 prompts the user 301 to look at an object (a tourist site in the virtual space, an imaginary building, or the like) that the user 402 is looking at, the user 301 will move his/her line of sight to the visual recognition area 404 of the user 402, which is an out-of-visual-recognition area for him/herself. There is concern that image generation of the visual recognition area 404 for the user 301 will be delayed if preparatory processing in order to render images in high resolution has not been applied for the visual recognition area 404 that is an out-of-visual-recognition area.

Delay in image generation is suppressed by generating high-resolution images or applying preparatory processing in order to render images in high resolution, with respect to the entire region of the out-of-visual-recognition area of the user 301. However, rendering high-resolution images, applying preparatory processing in order to render images in high resolution, and so forth, for the entire region of the out-of-visual-recognition area of the user 301, will increase the load on the hardware of the HMD 101. In the first embodiment, low-load generating of high-resolution images without delay can be realized even at a position to which the line of sight has moved, by the HMD 101 appropriately setting the second region for applying preparatory processing in order to render images in high resolution, out of the out-of-visual-recognition area of the user 301.

Hereinafter, description will be made regarding a case of displaying VR images on an HMD (head-mounted display device) as an example of a display device having an image processing device according to the present invention. Note that the present invention is applicable as long as the image processing device is one that is usable along with an HMD. The image processing device may be provided in the HMD, or may be provided in electronic equipment separate from the HMD. The HMD can also be understood as being a display device that has an image processing device and a display unit.

The user can wear the HMD on his/her head, or wear like goggles, and thus can view VR images from any viewpoint. The VR images displayed on the HMD include, in addition to 360-degree panorama pictures, real pictures shot with a camera for VR, virtual pictures generated in accordance with the VR form, and so forth. In the following description, situations are assumed in which images of virtual space are displayed on HMDs connected to a network, and users are provided with VR services such as games and various types of events (live performances, seminars, and so forth).

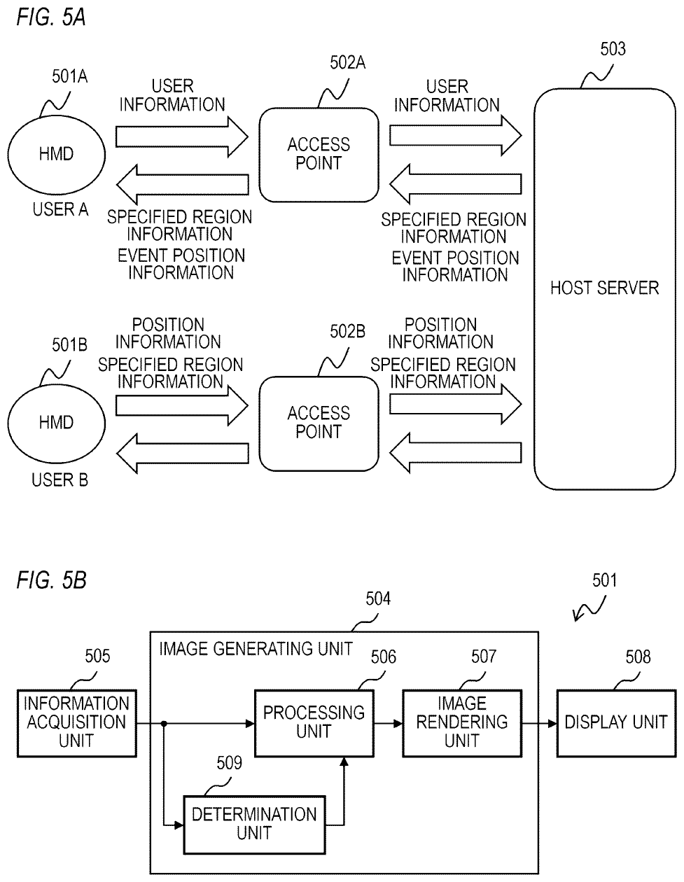

FIG. 5A exemplifies a configuration of a VR system according to the first embodiment. FIG. 5B is a block diagram exemplifying a functional configuration of HMDs 501A and 501B. Description in FIGS. 5A and 5B that is in common with FIGS. 1A and 1B will be omitted.

FIG. 5A illustrates the configuration of the VR system in a case in which a user A and a user B are participating in the same virtual tour. In the following, image generation processing in a case in which the user A moves his/her line of sight with the HMD 501A that the user A is wearing will be described. The HMD 501A is connected to a host server 503 via an access point 502A. The HMD 501B that the user B wears is connected to the host server 503 via an access point 502B. Note that the HMD 501A and the HMD 501B will also be collectively referred to as “HMDs 501”. Also, the access point 502A and the access point 502B will also be collectively referred to as “access points 502”.

The host server 503 receives information of users wearing the HMDs 501 connected to the host server 503, position information of the HMDs 501, and so forth, and centrally manages this information. The host server 503 transmits, to the HMDs 501, information of users wearing other HMDs 501, position information of the other HMDs 501, and so forth. The HMDs 501 can generate images in which the plurality of users are present in the same virtual space in a simulated manner, on the basis of the information received from the host server 503.

The HMDs 501 include detection units, and can detect (acquire) line-of-sight positions of the users, words uttered by the users, head movement of the users (including rotational velocity of heads of the users), pulse of the users, and so forth, as user information. The detection units of the HMD 501 are, for example, inertial sensors for detecting motion, sound collection devices such as microphones for detecting sound, noise level meters, pulse meters for measuring pulse, biometric sensors for detecting various types of biometric information, and eye-gaze detection systems for detecting lines of sight of the users, and so forth.

Also, the HMDs 501 can be operated by controllers connected to the HMDs 501 by wired or wireless connection. The HMDs 501 also detect messages (instructions) issued by button operations and so forth performed on the controllers, as user information.

In a case in which a plurality of users participate in a virtual tour, there are cases in which there are requests such as a user wanting to share his/her own visual recognition area with other users (wanting other to see his/her own visual recognition area). For example, in a case in which the user B who is visually recognizing a VR image provided by the host server 503 issues a request to share his/her own visual recognition area with the user A (hereinafter referred to as “share request”), the share request of the user B is transmitted to the host server 503.

Note that the visual recognition area is a region that the user B specifies as a sharing object (also referred to as “specified region” hereinafter), not restricted to a region that the user B is visually recognizing (region specified by the line of sight of the user B), and may be a region situated in a direction instructed by the user B. The user B can instruct the specified region by operation through speech (words), or by performing an operation on a predetermined operation member. The predetermined operation member may be an operation member that the HMD 501B is equipped with, or may be an operation member of a controller for operating the HMD 501B.

The user B can issue a share request for a specified region by uttering words to the user A, such as for example, “Look over here”, “Look at this”, “Wow”, and so forth. The HMD 501B can determine that a share request has been issued by recognizing predetermined words uttered by the user B such as those above. Also, the HMD 501B can determine that a share request has been issued in a case in which the user B specifies a region using the controller. Also, the HMD 501B may measure the pulse of the user B using a detection unit, and determine that a share request has been issued when the pulse speeds up. The specified region in this case may be a region that the user B is visually recognizing.

The host server 503 acquires (receives) the share request made by the user B from the HMD 501B that the user B is wearing. The host server 503 analyzes what position in the virtual space that the specified region of the user B is assigned. The host server 503 transmits information of the specified region that has been analyzed (hereinafter referred to as “specified region information”) to the HMD 501A that the user A is wearing. The specified region information includes information such as position, size, and so forth, of the specified region.

The HMD 501A of the user A sets the second region for applying preparatory processing in order to render images in high resolution, on the basis of the specified region information and the user information received from the host server 503.

Processing for displaying an image, generated on the basis of the first region that the user A is visually recognizing and the second region to which preparatory processing is applied in order to render images in high resolution, to the user, will be described with reference to FIG. 5B. FIG. 5B is a block diagram exemplifying the functional configuration of the HMD 501 according to the first embodiment. Note that the HMDs 501 (HMD 501A, HMD 501B) connected to the host server 503 each have the configuration illustrated in FIG. 5B. An information acquisition unit 505, a processing unit 506, an image rendering unit 507, and a display unit 508 of the HMD 501 are respectively the same as the information acquisition unit 105, the processing unit 106, the image rendering unit 107, and the display unit 108 of the HMD 101 illustrated in FIG. 1B, and accordingly description thereof will be omitted.

An image generating unit 504 of the HMD 501 has a determination unit 509 in addition to the processing unit 506 and the image rendering unit 507. The determination unit 509 determines the second region on the basis of the specified region information received from the host server 503, and the user information that the detection units of the HMD 501 detect. The determination unit 509 transmits information of the second region that has been determined to the processing unit 506. The processing unit 506 sets the area that the user is visually recognizing (central field of view) as the first region, and also sets the second region on the basis of the information that is received from the determination unit 509. The image rendering unit 507 generates a VR image to be displayed on the display unit 508 on the basis of the first region and the second region set by the processing unit 506.

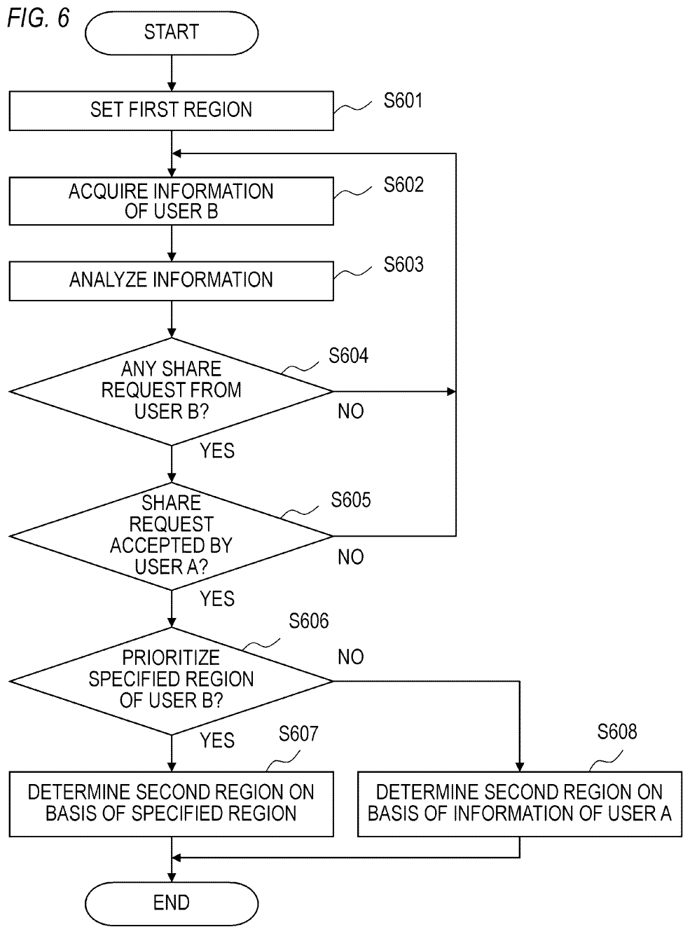

Processing for setting the second region will be described with reference to FIG. 6. FIG. 6 shows an example of setting processing of the second region in a case in which the HMD 501A that is worn by the user A receives a share request from the user B. The processing shown in FIG. 6 is started by a service being started by the VR system and the HMD 501A connecting to the host server 503. Note that in the following description part of the processing that is executed by the host server 503 may be executed by the HMD 501A, and part of the processing that is executed by the HMD 501A may be executed by the host server 503.

In step S601, the processing unit 506 of the HMD 501A sets the first region, which is the region to be rendered in higher resolution than in other regions in the VR image, on the basis of user information of the user A. The processing unit 506 can set the first region by a technique that is the same as that in foveated rendering. The processing unit 506 sets the region that the user A is visually recognizing as the first region, on the basis of information of a line-of-sight position of the user A that is included in the user information, for example.

In step S602, the host server 503 acquires user information of the user B. In step S603, the host server 503 analyzes the user information that is acquired in step S602, and generates image generation information for creating an image in which the user A and the user B are present in the same virtual space. The host server 503 transmits the image generation information that is generated to the information acquisition unit 505 of the HMD 501A.

In step S604, the host server 503 determines whether or not there has been a share request from the user B to the user A, with respect to a specified region that the user B specifies. In a case in which there has been a share request from the user B, the host server 503 acquires specified region information from the HMD 501B of the user B and performs transmission thereof to the information acquisition unit 505 of the HMD 501A, and the flow advances to step S605. In a case in which there is no share request from the user B, the host server 503 returns to step S602, and analysis of user information of the user B is continued.

In step S605, the determination unit 509 of the HMD 501A determines whether or not the user A has accepted the share request from the user B. The determination unit 509 can determine that the user A has accepted the share request from the user B in a case in which, for example, the user A turns to face the direction of the specified region. Also, the determination unit 509 can determine that the user A has not accepted the share request from the user B in a case in which the user A does not turn to face the direction of the specified region. The determination unit 509 can determine whether or not the user A has turned to face the direction of the specified region by acquiring the position and orientation of the HMD 501A by the detection units. In a case in which the user A accepts the share request from the user B, the processing advances to step S606. In a case in which the user A does not accept the share request from the user B, the processing returns to step S602, and analysis of user information of the user B is continued.

In step S606, the determination unit 509 determines whether or not to prioritize the specified region that is based on the share request from the user B, when determining the second region. The determination unit 509 determines whether or not to prioritize the specified region on the basis of the user information of the user A. For example, the determination unit 509 determines whether or not the user A has moved his/her line of sight, on the basis of rotational velocity of the head of the user A, and prioritizes the specified region in a case in which the user A has moved his/her line of sight. In a case of prioritizing the specified region, the processing advances to step S607. In a case of not prioritizing the specified region, the processing advances to step S608.

In step S607, the determination unit 509 determines the second region in the VR image for the user A to visually recognize, on the basis of the specified region. Note that in a case in which the rotational velocity of the head of the user A is faster than a threshold value of velocity set in advance, there is a possibility of the user A moving his/her line of sight to the specified region immediately, and accordingly the determination unit 509 determines the specified region to be the second region. Conversely, in a case in which the rotational velocity of the head of the user A is slower than the threshold value of velocity set in advance, there is a possibility of the user A stopping moving his/her viewpoint partway, before reaching the specified region, or gazing at a region partway on the way of moving to the specified region. In this case, the determination unit 509 may determine the visual recognition area of the user B, and a section up to reaching the visual recognition area of the user B, as being the second region.

In step S608, the determination unit 509 determines the second region in the VR image for the user A to visually recognize on the basis of the user information of the user A. In step S608, the user information is information of line-of-sight positions of the user, for example, and the determination unit 509 can determine the peripheral field of view that is distinguished by foveated rendering as the second region. The processing unit 506 sets the second region that is determined by the determination unit 509 in step S607 or S608 as being a region to which preparatory processing is applied in order to render images in high resolution.

In the processing of FIG. 6, the HMD 501A sets the second region on the basis of information of the line-of-sight position of the user A visually recognizing the VR image, and region information relating to a region that is set in accordance with conditions not related to the user A (e.g., the specified region specified by the user B). The HMD 501A generates the VR image on the basis of the first region set in step S601 and the second region set in step S607 or step S608. That is to say, the HMD 501A can generate the VR image by rendering the first region in high resolution, and rendering the second region with preparatory processing applied in order to render images in high resolution.

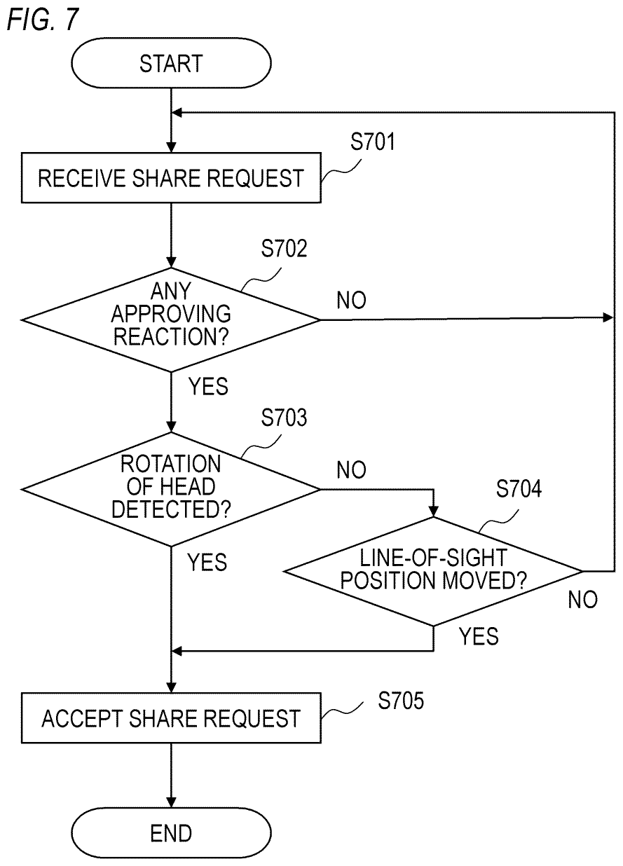

Determination of whether or not the user A accepts the share request for the specified region from the user B in step S605 in FIG. 6 will be described with reference to FIG. 7. FIG. 7 is a flowchart exemplifying acceptance determination processing regarding the share request.

In step S701, the information acquisition unit 505 of the HMD 501A receives the share request for the specified region from the user B. The information acquisition unit 505 can recognize that the share request for the specified region has been received from the user B by receiving specified region information via the host server 503, for example.

In step S702, the information acquisition unit 505 determines whether or not the user A has made a reaction approving of the share request, in response to the share request for the specified region from the user B. It is sufficient for the information acquisition unit 505 to be capable of detecting some sort of reaction in response to the share request, as a reaction of the user A approving of the share request.

Reactions by the user A approving of the share request include change in the line-of-sight position, uttering words, movement (rotation) of the head, operation on the controller, change in the pulse, and so forth. The information acquisition unit 505 acquires information of a reaction of the user A approving of the share request as user information. For example, the information acquisition unit 505 may analyze information of words uttered by the user A, to determine whether or not the user A has made a reaction approving of the share request from the user B. Also, the information acquisition unit 505 may receive a reaction of the user A from the controller for operating the HMD 501A, and determine whether or not there has been a reaction approving of the share request. Further, the information acquisition unit 505 may determine that there has been a reaction approving of the share request in a case in which at least one of change in the line-of-sight position, movement of the head, and change in pulse, of the user A, is detected. In a case in which there is a reaction of the user A approving of the share request, the processing advances to step S703. In a case in which there is no reaction of the user A approving of the share request, the processing returns to step S701.

In step S703, the information acquisition unit 505 determines whether or not rotation of the head of the user A has been detected by a detection unit. In a case in which rotation of the head of the user A has been detected, the information acquisition unit 505 determines that the share request for the specified region from the user B has been accepted by the user A, and advances to step S705. In a case in which rotation of the head of the user A has not been detected, the processing advances to step S704.

In step S704, the information acquisition unit 505 determines whether or not the line-of-sight position of the user A has moved to the specified region that is based on the share request from the user B. If the line-of-sight position of the user A has not moved to the specified region, the processing returns to step S701. If the line-of-sight position of the user A has moved to the specified region, the information acquisition unit 505 determines that the user A has intent to accept the share request from the user B and visually recognize the specified region, and advances to step S705.

In step S705, the information acquisition unit 505 determines that the user A accepts the share request for the specified region from the user B, and advances to step S606 in FIG. 6. The processing unit 506 is notified that the user A has accepted the share request for the specified region from the user B. The host server 503 and the HMD 501B that the user B is wearing are also notified that the user A has accepted the share request for the specified region from the user B.

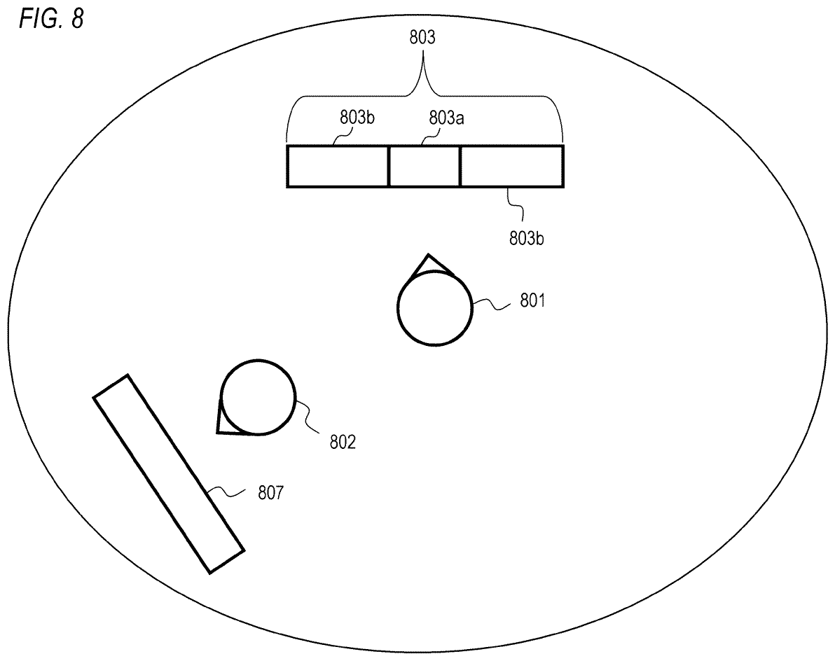

FIG. 8 is a diagram for describing effects of the first embodiment. A user 801 corresponds to the user A in the flowcharts in FIGS. 6 and 7. A user 802 corresponds to the user B in the flowcharts in FIGS. 6 and 7. A case will be described in which the line of sight of the user 801 moves from a visual recognition area 803 to a visual recognition area 807 of the user 802 (an out-of-visual-recognition area for the user 801). FIG. 8 is a plan view, looking down on the virtual space in the same way as in FIG. 3B. In FIG. 8, the user 801 is visually recognizing the visual recognition area 803. The visual recognition area 803 includes a first region 803a and second regions 803b. Also, the user 802 is visually recognizing the visual recognition area 807. The visual recognition area 807 is a visual recognition area of the user 802, and is an out-of-visual-recognition area for the user 801.

The user 802 issues a share request to the user 801 regarding his/her own visual recognition area 807. In a case in which the user 801 accepts the share request from the user 802, the processing unit 506 of the HMD 501A sets the visual recognition area 807 of the user 802 to the second region. The image rendering unit 507 applies preparatory processing for rendering images in high resolution to the visual recognition area 807 that has been set to the second region. Accordingly, in a case in which the user 801 moves his/her line of sight to the visual recognition area 807 in accordance with the share request from the user 802, no delay in image generation occurs, since preparation for rendering the image in high resolution has been performed in advance. Also, the HMD 501A does not have to prepare to render images in high resolution for the entire region of the virtual space in which the user A is present, and accordingly calculation resources to be used by the HMD 501A can be reduced.

In the first embodiment described above, the HMD 501 sets the second region on the basis of information of line-of-sight positions of the user visually recognizing the VR image, and region information relating to a region that is set in accordance with conditions not related to this user (e.g., a specified region specified by another user). Rendering is performed by applying preparatory processing for rendering in high resolution to the second region, and accordingly, the HMD 501 can realize image generation without delay with a low load, even if the line of sight of the user suddenly moves.

### Second Embodiment

The first embodiment shows an example of a VR system assuming a situation in which the user A and the user B are participating in the same virtual tour. In a second embodiment, an example is shown of a VR system assuming a situation in which a tour guide is present besides a plurality of users participating in the virtual tour. The configuration of the VR system and the functional configuration of the HMD 501 according to the second embodiment are the same as the configurations illustrated in FIGS. 5A and 5B described in the first embodiment, and accordingly description thereof will be omitted. In the following, image generation processing by the HMD 501A worn by the user A, in a case in which the user A moves his/her line of sight, will be described.

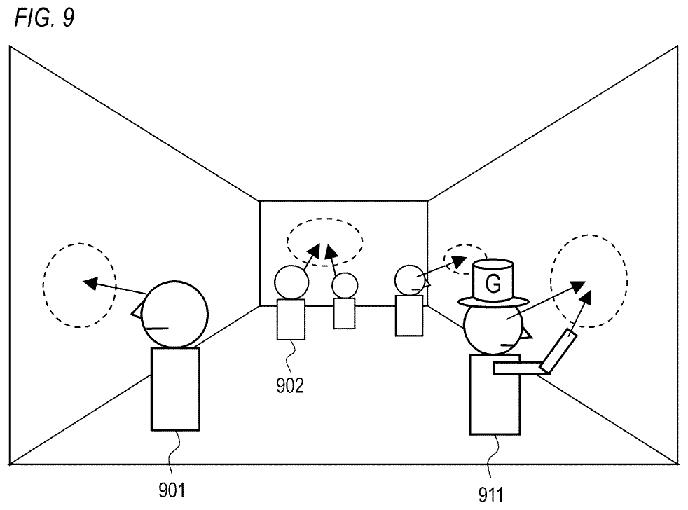

FIG. 9 illustrates a situation in which a plurality of users are participating in a virtual tour in the same virtual space. The user A (user 901) and the user B (user 902) are the users wearing the HMD 501A and the HMD 501B respectively, in the VR system described in FIG. 5A. Further, a tour guide 911 is present in the virtual space.

In the second embodiment, the second region to which preparatory processing is applied in order to render images in high resolution is set on the basis of region information that is set in accordance with information of the line of sight of the tour guide 911 and an instructed direction. A point of difference as to the first embodiment is that the HMD 501A sets the second region giving priority to a visual recognition area of the tour guide 911 or an area instructed by the tour guide 911, over a visual recognition area of the other user 902. This is because, in the virtual tour in which the tour guide 911 is present, due to the nature thereof, the users including the user 901 view the VR image each from their own free viewpoints under usual conditions, but focus on the direction instructed by the tour guide 911 each time the tour guide 911 introduces something.

Thus, the tour guide 911 is given priority over the user 902, as a user that issues share requests regarding specified regions. That is to say, in the second embodiment, the user that issues share requests regarding specified regions is selected from the plurality of users visually recognizing the VR image, on the basis of respective attributes. It is sufficient for the attributes of the users to be attributes by which whether a general user, or a user that attracts attention like the tour guide 911, can be differentiated.

The host server 503 sets an order of priority, taking into consideration the attribute information (attributes of whether a tour guide or not here) of the users and the tour guide 911 participating in the virtual tour, and so forth. The host server 503 transmits information of a specified region of the tour guide 911, who has a higher order of priority than the users participating in the tour, to the HMDs 501 of the users as a share request.

Note that the host server 503 may transmit information of the specified region of the tour guide 911 and information of specified regions of the users, with information of order of priority imparted thereto, to the HMDs 501 of the users. For example, the HMD 501A of the user A may select the specified region of which user (including the tour guide 911) to set as the second region, on the basis of the order of priority set by the user A, regardless of the order of priority set by the host server 503.

In the above second embodiment, the order of priority of the specified region of each user is set on the basis of attribute information of each of the users wearing the HMDs 501 connected to the host server 503. The HMDs 501 set the second region on the basis of information of regions set in accordance with conditions not related to the users themselves, such as the order of priority of specified regions of other users. By setting order of priority based on attributes of users, among the users that are present in the same virtual space, the HMDs 501 can set the second region so as to support a wide variety of forms of VR services. By applying preparatory processing to the second region in order to render images in high resolution, the HMDs 501 can suppress delay of image generation processing of VR images, and reduce processing load.

Note that the HMDs 501 can set, out of information of regions imparted with information of order of priority, a plurality of regions, as second regions. For example, in a situation in which the users are assumed to be moving their lines of sight frequently, the HMDs 501 can effectively suppress delay in image generation processing by selecting a plurality of regions from those higher in order of priority, and setting these as second regions.

### Third Embodiment

The first embodiment shows an example of a VR system assuming a situation in which the user A and the user B are participating in the same virtual tour. The second embodiment shows an example of a VR system assuming a situation in which the tour guide 911 is present besides the plurality of users participating in the virtual tour. In a third embodiment, an example is shown of a VR system assuming a situation in which a plurality of users are participating in the same virtual tour, but no tour guide 911 is present.

The configuration of the VR system and the functional configuration of the HMD 501 according to the third embodiment are the same as the configurations illustrated in FIGS. 5A and 5B described in the first embodiment, and accordingly description thereof will be omitted. In the following, image generation processing by the HMD 501A worn by the user A in a case in which the user A moves his/her line of sight will be described.

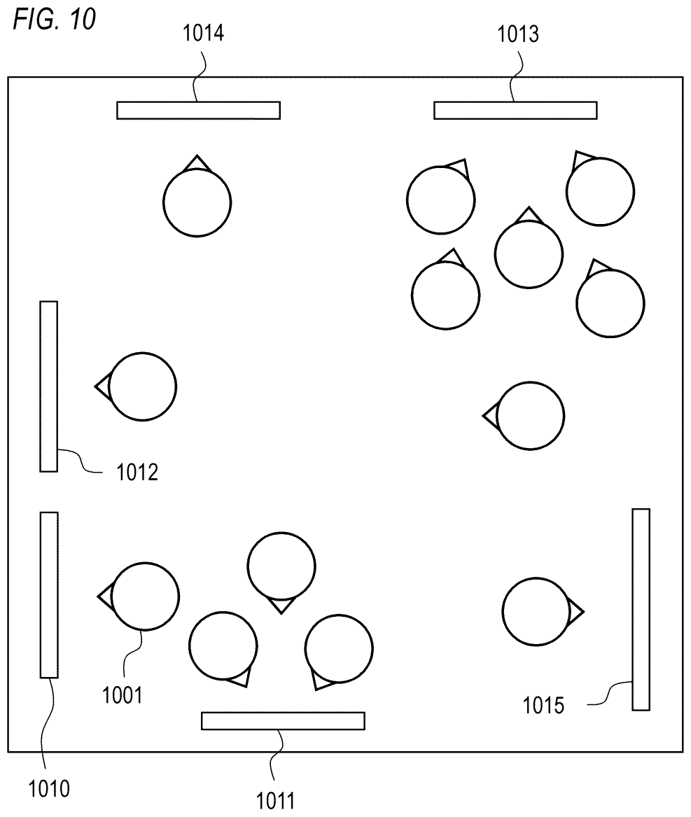

FIG. 10 illustrates a situation in which a plurality of users, besides the user A (user 1001), are present within the same virtual space. Regions 1010 to 1015 are regions in the virtual space that are visually recognized by the users. The region 1010 is a region that the user 1001 is visually recognizing. The regions 1011 to 1015 are regions that the user 1001 is not visually recognizing (out-of-visual-recognition areas).

The regions 1011 and 1012 are situated at positions closer to the user 1001 as compared to the regions 1013 to 1015. The number of users looking at the region 1011 is greater than the number of users looking at the region 1012. That is to say, a greater number of line-of-sight positions are detected at the region 1011 as compared to the region 1012.

Also, the regions 1013 to 1015 are situated at positions farther from the user 1001 as compared to the regions 1011 and 1012. The number of users looking at the region 1013 is greater than the number of users looking at the regions 1014 and 1015. That is to say, a greater number of line-of-sight positions are detected at the region 1013 as compared to the regions 1014 and 1015.

In the situation shown in FIG. 10, the HMD 501A can set the second region, to which preparatory processing is applied in order to render images in high resolution, on the basis of information of distances from the user 1001 to each of the regions, and information of the degree of concentration of line-of-sight positions of other users at each of the regions. For example, the HMD 501A sets the second region on the basis of information of a region that a great number of users are visually recognizing, out of the regions being visually recognized by each of the plurality of users other than the user 1001. Also, the HMD 501A sets the second region on the basis of information of a region that is closer to the region that the user 1001 is visually recognizing, out of the regions being visually recognized by each of the plurality of users other than the user 1001.

A point of difference as to the second embodiment is that the HMD 501A can set the second region on the basis of the positional relation to regions being visually recognized by other users, and the degree of concentration of line-of-sight positions in these regions, even in a case in which attribute information of the users is not acquired. There are cases in which, immediately after starting providing a VR service, the host server 503 has not received attribute information of the users from each of the HMDs 501 of the users. Even in such a case, the HMD 501A can set the second region on the basis of a region that is closer to the user A, out of the regions that the other users are visually recognizing. Also, the HMD 501A can set the second region on the basis of a region with a greater concentration of line-of-sight positions of other users, out of the regions that the other users are visually recognizing.

In the example in FIG. 10, with respect to the HMD 501A of the user 1001, a No. 1 priority region with No. 1 priority is set to the region 1011 that is at a position where the distance to the user 1001 is closer and at which lines of sight of other users are concentrated. Also, a No. 2 priority region with No. 2 priority is set to the region 1012 that is at a position where the distance to the user 1001 is closer and at which lines of sight of other users are not concentrated. Also, a No. 3 priority region with No. 3 priority is set to the region 1013 that is at a position where the distance from the user 1001 is farther and at which lines of sight of other users are concentrated.

The order of priority of each of the regions is set at each HMD 501 (for each user). The order of priority of each of the regions may be set by the host server 503, or may be set at each of the HMDs 501.

In a case of the host server 503 setting the order of priority, it is sufficient for the host server 503 to transmit information of the No. 1 priority region to the HMDs 501. Also, the host server 503 may transmit information of the No. 1 priority region to the No. 3 priority region to the HMDs 501, along with information of the order of priority. The HMDs 501 can use the information of the regions that is received and the information of the order of priority to appropriately set the second region.

Also, by receiving information used to set the order of priority from the host server 503, the HMDs 501 can set the order of priority of each region, and can appropriately set the second region.

In the above third embodiment, the processing units 506 of the HMDs 501 set the second region on the basis of information of regions set in accordance with conditions not related to the user, such as positional relation as to the regions that other users are visually recognizing, and the degree of concertation of line-of-sight positions at these regions. The image rendering units 507 of the HMDs 501 generate the VR image on the basis of the first region that is the visual recognition area of the users, and the second region that is set. By applying preparatory processing to the second region in order to render images in high resolution, the HMDs 501 can suppress delay in image generation processing of VR images, and reduce processing load.

### Fourth Embodiment

In the first to third embodiments, the second region, to which preparatory processing is applied in order to render images in high resolution, is set on the basis of information of regions set in accordance with conditions arising from other users who are present in the same virtual space. In a fourth embodiment, an example is shown of a VR system assuming a situation in which the host server 503 randomly generates events in virtual space that a VR image represents, rather than arising from other users.

The line-of-sight position of the user is not limited to moving in response to a share request from another user, and can also move in a case in which the host server 503 generates an event in the virtual space, unrelated to the intent of the user. In a case in which a location where the event occurs is an out-of-visual-recognition area for the user, there is concern that image generation of the location where the event occurs may be delayed. Examples of events that the host server 503 generates include a volcano erupting, a whale jumping at sea, shooting off fireworks, a shooting star appearing, an animal appearing, a bell ringing in a clock tower, and so forth.

The configuration of the VR system and the functional configuration of the HMD 501 according to the fourth embodiment are the same as the configurations illustrated in FIGS. 5A and 5B described in the first embodiment, and accordingly description thereof will be omitted.

The host server 503 of the VR system transmits event information relating to the event to the HMDs 501 of the users in advance. The event information includes information of region, time, and so forth, at which the event will occur. The HMDs 501 set the second region, to which preparatory processing is applied in order to render images in high resolution, on the basis of the event information.

In the above fourth embodiment, the HMDs 501 set the second region on the basis of information of a region where an event will occur, as information of a region set in accordance with conditions not related to the user. The HMDs 501 generate VR images on the basis of the first region that is the visual recognition area of the user, and the second region that is set. By applying preparatory processing to the second region in order to render images in high resolution, the HMDs 501 can suppress delay in image generation processing of VR images, and reduce processing load.

Note that the functional units (FIGS. 1B, 5B) of the image processing device (HMD) according to the first through fourth embodiments may be separate hardware, or may be otherwise. Functions of two or more functional units may be realized by common hardware. A plurality of functions of one functional unit may each be realized by separate hardware. Two or more functions of one functional unit may be realized by common hardware. Also, each of the functional units may be realized by hardware, or may be realized otherwise. For example, the image processing device may have a processor, and memory in which a control program is stored. Functions of at least part of the functional units that the image processing device has may be realized by the processor reading the control program out from the memory and executing the control program.

The above embodiments are only examples, and configurations obtained by appropriately modifying or changing the configurations of the above embodiments without departing from the spirit and scope of the present invention are also encompassed by the present invention. Also, configurations obtained by appropriately combining the configurations of the above embodiments are also encompassed by the present invention.

According to the present invention, in a case in which a user viewing a VR image moves his/her line of sight, low-load generation of high-resolution images can be performed without delay.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-017945, filed on Feb. 8, 2024, which is hereby incorporated by reference herein in its entirety.

1. An image processing device comprising one or more processors and/or circuitry configured to:
perform first setting processing to set a first region that is a region rendered in higher resolution than other regions in a VR image;
perform second setting processing to set a second region to which preparatory processing is applied in order to perform rendering in the resolution of the first region, based on user information relating to a first user visually recognizing the VR image, and region information relating to a region that is set in accordance with conditions not related to the first user; and
perform generating processing to generate the VR image based on the first region and the second region.

2. The image processing device according to claim 1, wherein the region information is information of a region specified by a second user visually recognizing the VR image.

3. The image processing device according to claim 2, wherein the region specified by the second user includes a region that the second user is visually recognizing.

4. The image processing device according to claim 2, wherein the region specified by the second user is specified by an operation by speech by the second user, or by an operation on a predetermined operation member by the second user.

5. The image processing device according to claim 2, wherein the second user is selected from a plurality of users visually recognizing the VR image, based on attributes of each of the plurality of users.

6. The image processing device according to claim 1, wherein the region information is information of a region that more users are visually recognizing, out of regions being visually recognized by a plurality of users who are different from the first user.

7. The image processing device according to claim 1, wherein the region information is information of a region that is closer to a region that the first user is visually recognizing, out of regions being visually recognized by a plurality of users who are different from the first user.

8. The image processing device according to claim 1, wherein the region information is information of a region in which an event will occur in virtual space that the VR image represents.

9. The image processing device according to claim 1, wherein the first region is set based on a region that the first user is visually recognizing.

10. The image processing device according to claim 1, wherein the VR image is a panorama image.

11. The image processing device according to claim 1, wherein the one or more processors and/or the circuitry is further configured to:
perform acquisition processing to acquire the user information.

12. The image processing device according to claim 1, wherein the user information includes information of at least one of a line-of-sight position, a word, movement of a head, and pulse, of the user.

13. A head-mounted display device comprising:
the image processing device according to claim 1; and
a display configured to display the VR image.

14. An image processing method comprising:
a step of setting a first region that is a region rendered in higher resolution than other regions in a VR image;
a step of setting a second region to which preparatory processing is applied in order to perform rendering in the resolution of the first region, based on user information relating to a first user visually recognizing the VR image, and region information relating to a region that is set in accordance with conditions not related to the first user; and
a step of generating the VR image based on the first region and the second region.

15. A non-transitory computer readable medium that stores a program, wherein the program causes a computer to execute the image processing method comprising:
a step of setting a first region that is a region rendered in higher resolution than other regions in a VR image;
a step of setting a second region to which preparatory processing is applied in order to perform rendering in the resolution of the first region, based on user information relating to a first user visually recognizing the VR image, and region information relating to a region that is set in accordance with conditions not related to the first user; and
a step of generating the VR image based on the first region and the second region.

16. The image processing device according to claim 2, wherein the user information includes information of at least one of a line-of-sight position, a word, movement of a head, and pulse, of the user.

17. The image processing device according to claim 3, wherein the user information includes information of at least one of a line-of-sight position, a word, movement of a head, and pulse, of the user.
